(19) United States
(12) Patent Application Publication
(10) Pub. No.: US 2025/0020350 A1
(43) Pub. Date: Jan. 16, 2025

(54) System And Method For Remote Monitoring Of Environmental Conditions In A Plurality Of Buildings

(71) Applicant: ZapCarbon Limited, Leighton Buzzard (GB)

(72) Inventors: Andrew SMITH, Buckinghamshire (GB); Dale HOLROYD, Bedfordshire (GB)

(73) Assignee: ZapCarbon Limited, Leighton Buzzard (GB)

(21) Appl. No.: 18/713,551

(22) PCT Filed: Nov. 25, 2022
(86) PCT No.: PCT/GB2022/052993

§ 371 Date: May 24, 2024

(30) Foreign Application Priority Data
Nov. 25, 2021 (GB) 2117045.1

(51) Int. Cl. F24F 11/58; F24F 11/32; F24F 11/46; F24F 110/10; F24F 110/20; F24F 110/50

(52) U.S. Cl. CPC F24F 11/58; F24F 11/32; F24F 11/46; F24F 2110/10; F24F 2110/20; F24F 2110/50

(57) ABSTRACT

Apparatus for remote monitoring of environmental conditions within a plurality of buildings is disclosed, comprising a plurality of sensor modules each disposed within a respective one of the plurality of buildings, and a server disposed at a location remote from the buildings. Each sensor module is configured to measure one or more parameters indicative of an environmental condition, and transmit data indicative of values of the respective one or more parameters to the server. The server is configured to determine whether the received data is indicative of an undesired condition in at least one building, and to take a predefined corrective action to mitigate said undesired condition depending on whether the received data is indicative of the undesired condition. Optionally, the server and/or sensor modules comprise a sensor controller, which can reduce the power consumption of a sensor module under circumstances where the environmental condition can be monitored less frequently.

### TECHNICAL FIELD

The present invention relates to remotely monitoring environmental conditions. More particularly, the present invention relates to an apparatus, method and computer program for remote monitoring of environmental conditions within a plurality of buildings.

### BACKGROUND

Systems have been developed which can remotely monitor conditions such as temperature and humidity at a building, using sensors placed at appropriate locations within the building. The sensors are typically hardwired into the mains to enable continual operation and collection of data, and consequently require installation by a suitably qualified professional. This increases the cost and inconvenience associated with installing such a system, in turn hindering their widespread adoption. There is therefore a need in the art for a remote building monitoring system that can be easily and quickly installed by an untrained user.

### SUMMARY OF THE INVENTION

According to a first aspect of the present invention, there is provided apparatus for remote monitoring of environmental conditions within a plurality of buildings, the apparatus comprising: a plurality of sensor modules each disposed within a respective one of the plurality of buildings, each sensor module being configured to measure one or more parameters indicative of an environmental condition, the plurality of sensor modules including one or more self-powered sensor modules each comprising an internal power source for powering said sensor module; and a server communicatively coupled to the plurality of sensor modules to receive data indicative of values of the respective one or more parameters measured by each of the plurality of sensor modules, the server being disposed at a location remote from the plurality of buildings, wherein the server is configured to determine whether the received data is indicative of an undesired condition in at least one of the plurality of buildings, and take a predefined corrective action to mitigate said undesired condition in dependence on a determination that the received data is indicative of the undesired condition.

In some embodiments according to the first aspect, the apparatus comprises a sensor controller configured to control one of the plurality of sensor modules so as to reduce a rate of power consumption by said sensor module in dependence on a determination that at least one predefined criterion is satisfied, the at least one predefined criterion being indicative of a circumstance under which the environmental condition can be monitored less frequently.

In some embodiments according to the first aspect, the sensor controller is configured to decrease a sampling rate at which the sensor module measures at least one of the one or more parameters, thereby to reduce the rate of power consumption by the sensor module.

In some embodiments according to the first aspect, the sensor controller is configured to increase a time interval at which the sensor module transmits its data to the server, thereby to reduce the rate of power consumption by the sensor module.

In some embodiments according to the first aspect, the sensor controller is configured to switch the sensor module from a normal operating mode into a sleep mode in which one or more functions of the sensor module are disabled, thereby to reduce the rate of power consumption by the sensor module.

In some embodiments according to the first aspect, the sensor controller is configured to periodically wake the sensor module from the sleep mode to re-measure the one or more parameters indicative of the environment condition, and to switch the sensor module back into the normal operating mode in dependence on the re-measured value of the one or more parameters deviating from a previously-measured value by more than a threshold amount.

In some embodiments according to the first aspect, the at least one predefined criterion indicative of a circumstance under which the environmental condition can be monitored less frequently comprises: the values of the respective one or more parameters measured by the sensor module remaining within a certain range over at least a minimum length of time; and/or the values of the respective one or more parameters measured by the sensor module being indicative of an environmental condition associated with a low likelihood of the undesired condition occurring; and/or a current time being within a defined time period associated with a low likelihood of the undesired condition occurring.

In some embodiments according to the first aspect, the server comprises the sensor controller.

In some embodiments according to the first aspect, the sensor controller is disposed in the sensor module, such that each of the plurality of sensor modules comprises a respective sensor controller.

In some embodiments according to the first aspect, the one or more self-powered sensor modules each comprise at least one sensor for measuring the one or more parameters, and a communications interface for transmitting the data to the server, wherein the internal power source is configured to supply electrical power to the at least one sensor and the communications interface.

In some embodiments according to the first aspect, the plurality of sensor modules include one or more mains-powered sensor modules, each mains-powered sensor module comprising at least one sensor for measuring the one or more parameters, a communications interface for transmitting the data to the server, and a mains power adaptor connectable to a source of mains power to supply electrical power to the at least one sensor and the communications interface.

In some embodiments according to the first aspect, the server is communicatively coupled to one or more of the plurality of sensor modules via a Global System for Mobile, GSM, communications network.

In some embodiments according to the first aspect, the one or more parameters measured by the plurality of sensor modules include one or more of:
ambient temperature;
ambient humidity;
a concentration of carbon dioxide;
a concentration of carbon monoxide;
a concentration of nitrous oxide species, NOx;
an air quality index, AQI;
a concentration of particulate matter;
a concentration of smoke particles;
a concentration of volatile organic compounds, VOCs; and
an ambient noise level.

In some embodiments according to the first aspect, the undesired condition comprises one or more of:
a temperature and/or humidity condition conducive to the growth of mould;
a temperature condition indicative of a low level of insulation and/or heating;
a temperature and power usage condition indicative of an inefficient form of heating being used in the building;
a humidity condition indicative of over-occupancy of the building; and
a discrepancy between an actual energy performance of the building, as determined based on the received data, and an expected energy performance of the building.

In some embodiments according to the first aspect, the predefined corrective action comprises outputting a notification indicative of the undesired condition, the notification including information for identifying the building in which the undesired condition has been detected.

In some embodiments according to the first aspect, the predefined corrective action comprises outputting a notification indicative of the undesired condition, the notification including information on a recommended course of action to mitigate the undesired condition.

In some embodiments according to the first aspect, the server is configured to subsequently determine whether the recommended course of action has been followed, based on data indicative of values of the respective one or more parameters measured by one or more of the plurality of sensor modules disposed within the building in which the undesired condition was detected at a time after the notification was outputted, and to output a further notification in dependence on a determination that the recommended course of action has not been followed.

In some embodiments according to the first aspect, the one or more parameters include at least one parameter relating to an indoor air quality, such that the received data is indicative of the indoor air quality within one or more of the plurality of buildings, and the server is configured to compare the received data indicative of the indoor air quality to other data indicative of an outdoor air quality at a respective one of the plurality of buildings, and to remotely control a ventilation system to increase a level of ventilation at said one of the plurality of buildings in dependence on a determination that the outdoor air quality is superior to the indoor air quality.

According to a second aspect of the present invention, there is provided a server for use in apparatus according to the first aspect, the server comprising: a communication interface for communicatively coupling the server to the plurality of sensor modules to receive data indicative of values of the respective one or more parameters measured by each of the plurality of sensor modules; one or more processors; and computer readable memory arranged to store computer program instructions which, when executed by the one or more processors, cause the server to: determine whether the received data is indicative of an undesired condition in at least one of the buildings; and take a predefined corrective action to mitigate said undesired condition in dependence on a determination that the received data is indicative of the undesired condition.

According to a third aspect of the present invention, there is provided a computer-implemented method of remotely monitoring environmental conditions within a plurality of buildings, the method comprising: receiving, at a server disposed at a location remote from the plurality of buildings, data indicative of values of respective parameters measured by at least one sensor for measuring a parameter indicative of an environmental condition in each of a plurality of sensor modules each disposed within a respective one of the plurality of buildings; determining whether the received data is indicative of an undesired condition in at least one of the buildings; and taking a predefined corrective action to mitigate said undesired condition in dependence on a determination that the received data is indicative of the undesired condition.

According to a fourth aspect of the present invention, there is provided a non-transitory computer-readable storage medium arranged to store computer program instructions which, when executed, cause performance of a method according to the third aspect.

### BRIEF DESCRIPTION OF THE DRAWINGS

Embodiments of the present invention will now be described, by way of example only, with reference to the accompanying drawings, in which:

FIG. 1 illustrates apparatus for remote monitoring of environmental conditions within a plurality of buildings, according to an embodiment of the present invention;

FIG. 2 illustrates a sensor module configured to measure a plurality of parameters indicative of an environmental condition, according to an embodiment of the present invention;

FIG. 3 illustrates a server for remote monitoring of environmental conditions within a plurality of buildings, according to an embodiment of the present invention;

FIG. 4 is a flowchart illustrating a method of remotely monitoring environmental conditions within a plurality of buildings, according to an embodiment of the present invention;

FIG. 5 is a flowchart illustrating a method of controlling a sensor module to reduce the rate of power consumption by the sensor module, according to an embodiment of the present invention;

FIG. 6 is a flowchart illustrating a method of alerting a user when an undesired condition has been detected, and checking whether the recommended corrective action has been taken, according to an embodiment of the present invention;

FIG. 7 is a flowchart illustrating a method of automatically controlling a ventilation system, according to an embodiment of the present invention;

FIGS. 8A and 8B are flowcharts illustrating a method of registering a new sensor in a remote monitoring system, such as the one shown in FIG. 1, according to an embodiment of the present invention;

FIG. 9 is a flowchart illustrating a method of determining an actual energy performance of a building based on data from one or more temperature sensors disposed within the building, according to an embodiment of the present invention; and

FIG. 10 illustrates an algorithm for determining an actual energy performance of a building based on temperature sensor data and energy consumption data, according to an embodiment of the present invention.

### DETAILED DESCRIPTION

In the following detailed description, only certain exemplary embodiments of the present invention have been shown and described, simply by way of illustration. As those skilled in the art would realise, the described embodiments may be modified in various different ways, all without departing from the scope of the present invention. Accordingly, the drawings and description are to be regarded as illustrative in nature and not restrictive. Like reference numerals designate like elements throughout the specification.

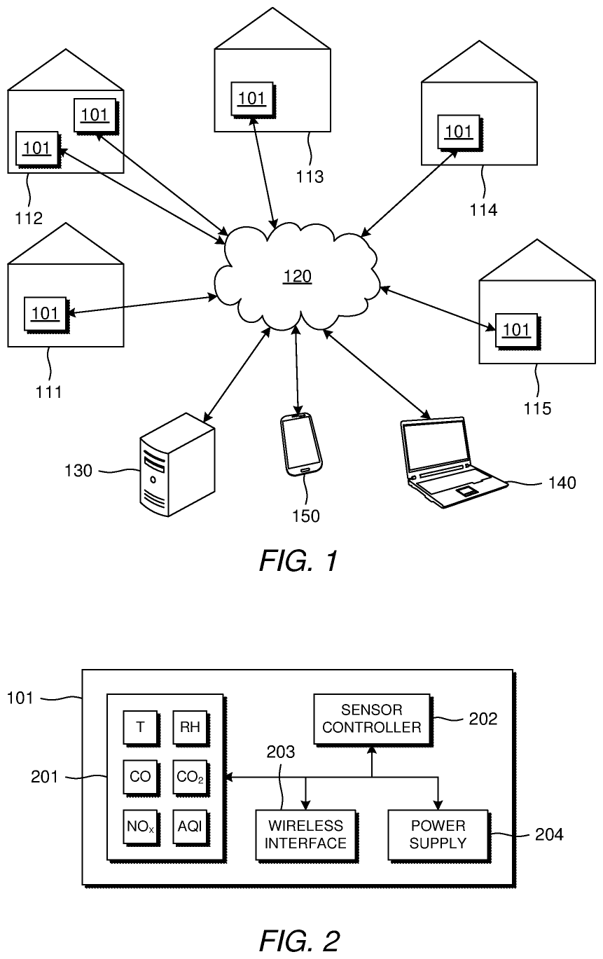

Referring now to FIGS. 1 to 4, an apparatus and method for remote monitoring of environmental conditions within a plurality of buildings is illustrated, according to an embodiment of the present invention. As shown in FIG. 1, the apparatus comprises a plurality of sensor modules 101, and a server 130 communicatively coupled to the plurality of sensor modules 101 such that the server 130 can receive data from the plurality of sensor modules 101. In the present embodiment, the plurality of sensor modules 101 are configured to transmit data to the server 130 via a Global System for Mobile (GSM) communications network 120, and as such each sensor module 101 comprises a GSM wireless communications module and subscriber identity module (SIM) card for enabling the sensor module 101 to connect to the GSM network 120.

Although a GSM communications network 120 is used in the present embodiment, in other embodiments the server 130 may communicate with the plurality of sensor modules 101 via any other suitable communications protocol. For example, in some embodiments the plurality of sensor modules 101 may communicate with the server 130 via the Internet or a Wide Area Network (WAN). GSM is an example of a cellular wireless communication protocol, also referred to commonly as ‘2G’. In some embodiments the plurality of sensor modules 101 may communicate with the server 130 using other communications protocols instead of or in addition to GSM, including but not limited to: other forms of cellular wireless communication protocols such as 3G, 4G and 5G; non-cellular wireless communications protocols such as WiFi, Li-Fi, Bluetooth Low Energy (BLE), Sigfox, LoRa, Zigbee, Z-Wave, or Thread; and wired communications protocols such as Ethernet, RS-232, RS-485, and Universal Serial Bus (USB).

An advantage of using a cellular network, such as GSM, to transmit data from the sensor modules 101 to the server 130 is that the sensor modules 101 can communicate independently with the server 130 without having to rely on a local connection, such as Bluetooth, a WiFi network and/or an associated broadband connection. This can make installation of the sensor modules 101 more convenient for an end user, for example an owner or occupier of one of the plurality of buildings 111, 112, 113, 114, 115, since there is no need to configure the sensor modules 101 to connect to a local network, or to subscribe to or pay for access to a network such as Wifi. Instead, as soon as the sensor module 101 is powered on, it can immediately start collecting data and relaying the data back to the server 130 via the GSM wireless communications module.

The plurality of sensor modules 101 are each disposed within a respective one of the plurality of buildings 111, 112, 113, 114, 115. Each one of the plurality of sensor modules 101 is configured to measure one or more parameters indicative of an environmental condition in the respective building 111, 112, 113, 114, 115 in which the sensor module 101 is disposed. Examples of parameters that may be monitored by the plurality of sensor modules 101 in embodiments of the present invention include, but are not limited to:
ambient temperature;
ambient humidity;
a concentration of carbon dioxide;
a concentration of carbon monoxide;
a concentration of nitrous oxide species, NOx;
an air quality index, AQI;
a concentration of particulate matter;
a concentration of smoke particles;
a concentration of volatile organic compounds, VOCs; and
an ambient noise level.

The server 130 is disposed at a location that is remote from the plurality of buildings 111, 112, 113, 114, 115. In other words, the server 130 is not situated at the same location as any of the plurality of buildings 111, 112, 113, 114, 115. In general, the server 130 can be located anywhere that a suitable communications link is available to allow the server 130 to receive data from the plurality of sensor modules 101. For example, the server 130 may be located in a different neighbourhood, city, state, country, or even on a different continent, to some or all of the plurality of buildings 111, 112, 113, 114, 115. Hence, a system comprising the plurality of sensor modules 101 and the server 130 can be referred to as a ‘remote building monitoring system’, in the sense that it is not necessary for the server 130 to be located within a certain distance of any of the plurality of buildings 111, 112, 113, 114, 115.

The server 130 receives data indicative of values of the respective one or more parameters measured by each of the plurality of sensor modules 101, via the network 120. As will be described in more detail below, the server 130 is configured to determine whether the received data is indicative of an undesired condition in at least one of the plurality of buildings, for example a condition which may be conducive to the growth of black mould or which may potentially be damaging to the fabric of the building.

The server 130 is further configured to take a predefined corrective action to mitigate said undesired condition in dependence on a determination that the received data is indicative of the undesired condition. For example, the corrective action may comprise outputting a notification to a user device 140, such as a laptop, desktop or tablet computer, mobile phone, smartphone 150, or wearable electronic device, so that a user of the device can intervene to improve the environmental condition at the building. In some embodiments the corrective action may comprise generating a prompt for a customer service agent to contact the resident and/or landlord of the building in which the undesired condition has been detected, and/or may comprise triggering a notification such as an automated communication to the resident and/or landlord, for example an automated phone call, text message, email, or push notification to a smartphone app.

By automating the collection and analysis of data from potentially a very large number of sensors, for example hundreds or thousands of sensors, embodiments of the present invention can advantageously detect undesired conditions that might otherwise go undetected entirely, or for a long period of time, if relying on human monitoring and analysis of data. For example, in some embodiments the server 130 may be configured to receive and analyse data comprising thousands of sensor readings per day across hundreds or even thousands of buildings.

A further benefit of using the server 130 to automate the collection and analysis of such data is that it can be possible to detect undesired conditions and take corrective action substantially in real-time. For example, if the server 130 identifies a spike in temperature and/or humidity in data received from a sensor located in a hallway adjacent to a bathroom, the server 130 may determine that an undesired condition exists in that a door between the hallway and bathroom may have been left open while a shower or bath is in use. In such a scenario, the server 130 can detect this undesired condition as soon as updated data is received from the hallway sensor module 101 and can automatically take corrective action, for example by immediately sending a notification to a resident of the building advising them to shut the bathroom door.

When such a notification is issued, the notification may include information for identifying the building in which the undesired condition has been detected. For example, this may assist a landlord who receives the notification in identifying which one of their properties the notification relates to. In some embodiments, the notification may be in the form of a personalised message to the building's resident.

For example, the personalised message may be generated based on information that is stored at the server 130 in a local database, or in a remote database accessible to the server 130, such as information about the resident, the building, its heating/cooling system, knowledge of how the resident operates within the building, and/or any previous history of messages sent to the resident. For example, the personalised message may indicate whether any previous message(s) relating to the same undesired condition have previously been sent to the resident, and may remind them to take any corrective action that was advised in the previous message(s). Examples of information that may be stored in a local database at the server 130 and/or in a remote database accessible to the server 130 include, but are not limited to:
information about the building's resident(s), such as their phone number(s), age(s), and any known medical issues or vulnerabilities;
information about the building, such as the type and/or level of performance of its heating/cooling system, insulation levels, effectiveness of ventilation/extraction, thermographic analysis (IR pictures), locations of known damp spots, etc;
knowledge of how the resident operates within the building, for example if it has been noticed during a home visit that resident has left a lid off a boiling pot when cooking, or dries clothes indoors and/or leaves bathroom doors open without adequate ventilation;
previous history of messages sent to the resident(s);
sensor identification code(s) for any sensor modules 101 installed in the building; and
location of each sensor module(s), stored in association with each sensor's identification code, such that the personalised message can inform the user as to the location in which the undesired condition was detected.

The plurality of sensor modules 101 include one or more self-powered sensor modules each comprising an internal power source for powering said sensor module. Depending on the embodiment, all of the plurality of sensor modules 101 may be self-powered sensor modules, or only some of the plurality of sensor modules 101 may be self-powered sensor modules. In some embodiments the plurality of sensor modules 101 comprise one or more self-powered sensor modules and one or more mains-powered sensor modules, wherein each mains-powered sensor module comprises a mains power adaptor connectable to a source of mains power to supply electrical power to components of the mains-powered sensor module.

FIG. 2 schematically illustrates a self-powered sensor module 101 suitable for use as one of the plurality of sensor modules in the apparatus of FIG. 1. The self-powered sensor module 101 comprises at least one sensor 201 for measuring one or more parameters, a sensor controller 202 for controlling operations of the sensor module 101, a communications interface 203 for communicating with the server 130, and a power supply 204 for providing electrical power to the at least one sensor 201, the sensor controller 202 and the communications interface 203. In the present embodiment the communications interface 203 is a GSM wireless communications module 203 which allows the sensor 101 to transmit data to the server 130 via a GSM network 120. However, as noted above, in some embodiments the sensor module 101 may communicate with the server 130 via a wired interface rather than a wireless interface. Accordingly, in some embodiments the communications interface 203 may comprise a wired interface instead of, or in addition to, a wireless interface.

In the present embodiment, the sensor module 101 comprises a plurality of sensors 201, including a temperature sensor arranged to measure an ambient temperature, a relative humidity (RH) sensor arranged to measure an ambient humidity, a CO₂ sensor arranged to measure a concentration of carbon dioxide, a CO sensor arranged to measure a concentration of carbon monoxide, an NOx sensor arranged to measure a concentration of nitrous oxide species, NOx, and an air quality sensor arranged to measure an air quality index, AQI. It should be appreciated that embodiments of the present invention are not limited to this particular combination of sensors and measured parameters. In other embodiments a sensor module 101 may comprise any number of sensors, in other words one or more sensors, depending on the parameters that the sensor module 101 is required to monitor.

In a self-powered sensor module 101, the power supply 204 may comprise a suitable power source capable of providing sufficient power to operate other components of the sensor module 101, including but not limited to the sensor controller 202 and the communications interface 203. One example of a suitable power source for a self-powered sensor module is a battery, which could be a non-rechargeable battery or a rechargeable battery. In some embodiments, the power supply 204 in a self-powered sensor module 101 may comprise an alternative source of power other than a battery, for example a solar panel or an energy harvesting module configured to generate electrical power from harvested energy, such as kinetic energy in the form of vibrations, or electromagnetic energy such as background radio frequency (RF) waves.

As noted above, in some embodiments the plurality of sensor modules 101 may include one or more mains-powered sensor modules. In a mains-powered sensor module 101, the power supply 204 may comprise a mains power adaptor connectable to a source of mains power to supply electrical power to the other components of the sensor module 101, such as the at least one sensor 201 and the communications interface 203.

Although in the present embodiment the plurality of sensor modules include one or more self-powered sensor modules, each comprising an internal power source for powering said sensor module, the use of self-powered sensor modules is not essential in other embodiments of the invention. For example, in other embodiments the plurality of sensor modules may solely comprise mains-powered sensor modules, without any self-powered sensor modules. In some embodiments, a combination of self-powered and mains-powered sensor modules may be used in the same system, such that the plurality of sensor modules includes one or more self-powered sensor modules and one or more mains-powered sensor modules.

As noted above, the server 130 is configured to take a predefined corrective action to mitigate said undesired condition in dependence on a determination that data received from the sensor modules 101 is indicative of an undesired condition. Examples of undesired conditions that can be determined by the server 130 based on the received sensor data, depending on the parameters that are measured by the sensor modules 101, include but are not limited to:
Relative humidity (% RH) exceeding a % RH threshold;
Temperature (T) being higher than an upper T threshold;
Temperature being lower than a lower T threshold;
Combination of T and % RH being indicative of a condition conducive to mould growth;
An observed temperature profile, as determined from a plurality of T measurements over a period of time, being indicative of a “fuel poverty” situation (i.e. a situation in which the resident cannot afford to heat the building to a minimum temperature some or all of the time);
The observed temperature profile being indicative of an inefficient usage of the building's heating system;
The observed temperature profile being indicative of the use of non-thermostatically controlled heating apparatus, such as fan heaters, which are known to be inefficient compared to other heating solutions;
The observed temperature profile being indicative of poor quality or insufficient (i.e. low level of) insulation;
The observed temperature profile being indicative of a discrepancy between an actual energy performance of the building, as determined based on the received sensor data, and an expected energy performance of the building (for example, based on an Energy Performance Certificate, EPC, of the building);
An observed humidity pattern, as determined from a plurality of % RH measurements over a period of time, being indicative of occupant behaviour likely to lead to conditions conducive to growth of mould (or other potentially harmful conditions), for example using a shower without adequate ventilation leading to an excessive increase in % RH in the bathroom;
The observed humidity pattern being indicative of over-occupancy of the building;
An indoor air quality, as measured by a sensor module 101, being less than a reference air quality value (e.g. a value indicative of the outdoor air quality at the building's location) by more than a threshold difference (delta) value;
CO₂ exceeding a threshold CO₂ level; and
CO exceeding a threshold CO level.

By automatically taking a corrective action, such as alerting the resident, landlord, or another individual, whenever such conditions are detected, embodiments of the present invention can ensure that the condition can be corrected at an early stage. Early intervention can in turn lead to improved health outcomes for occupants, and can help to avoid deterioration in the fabric of the building.

For example, when the undesired condition is an environmental condition known to be conducive to mould growth, such as a particular combination of T and % RH values, the corrective action taken by the server 130 may be to remotely control a ventilation system of the building so as to increase the level of ventilation and therefore reduce the % RH to a lower level. In other embodiments, for example where the building does not have a ventilation system that can be remotely controlled, the corrective action taken by the server 130 may be to automatically send a communication to the resident advising them to increase the level of ventilation. However, it should be appreciated that increasing a level of ventilation is only one example of an action that could be taken to reduce the risk of mould growth in a building. Examples of other actions that could be taken, either automatically by the server 130 or upon a user being prompted by the server 130 to take the necessary action, include but are not limited to: controlling a heating system in the building to raise the internal temperature to a higher level; activating a dehumidifier in the building to reduce the % RH level (or installing a dehumidifier, if one is not already installed); identifying and fixing a source of excess moisture (e.g. a leaking pipe, or leaking seal around a shower or bath); improving the building's insulation; taking action to contain humidity better, such as activating, installing, replacing and/or repairing an extractor fan, or closing a bathroom doors while a shower or bath is in use.

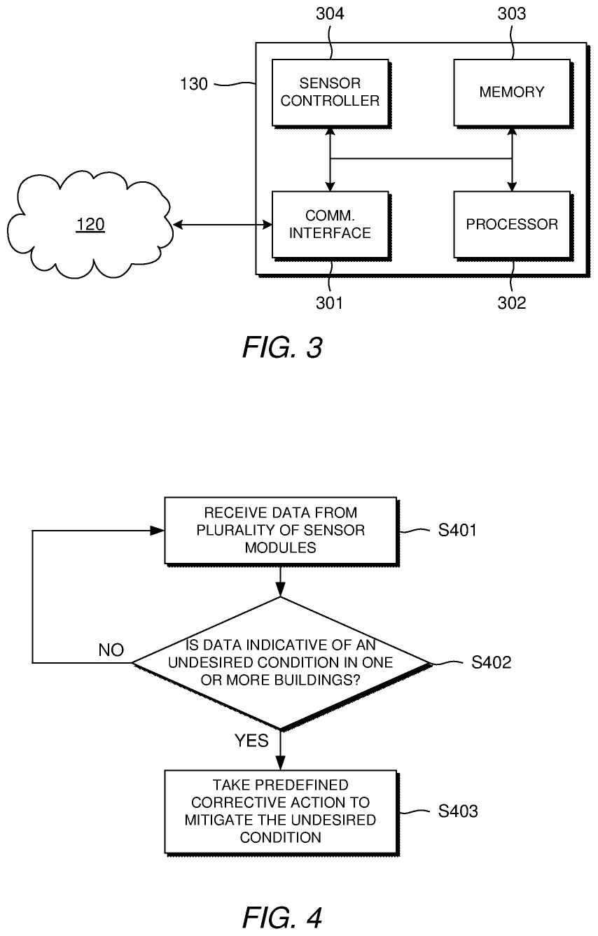

FIG. 3 schematically illustrates the server 130 in the apparatus of FIG. 1, according to an embodiment of the present invention. The server 130 comprises a communication interface for communicatively coupling the server 130 to the plurality of sensor modules 101 to receive data indicative of values of the respective one or more parameters measured by each of the plurality of sensor modules 101, for example via the network 120. The server 130 further comprises one or more processors 302, and computer readable memory 303 arranged to store computer program instructions which, when executed by the one or more processors 302, cause the server 130 to perform a method as shown in FIG. 4. The memory may comprise any suitable computer-readable memory capable of storing computer program instructions, and could be transitory memory such as random access memory (RAM), or non-transitory memory such as a magnetic hard disk drive (HDD) or solid state drive (SSD).

In more detail, in step S401 the server 130 receives data indicative of values of respective parameters measured by the at least one sensor 201 for measuring a parameter indicative of an environmental condition, in each of a plurality of sensor modules 101 each disposed within a respective one of the plurality of buildings 111, 112, 113, 114, 115.

Next, in step S402 the server 130 determines whether the received data is indicative of an undesired condition in at least one of the buildings. If no such condition is detected, the server 130 returns to S401 and continues to receive and monitor data from the sensor modules 101. When an undesired condition is detected in step S402, the server proceeds to step S403 and takes a predefined corrective action to mitigate said undesired condition, as has been described above.

In the present embodiment the server 130 also comprises a sensor controller 304 for remotely controlling operation of one or more of the server modules 101, as will be described in more detail below. Although the sensor controller 304 is illustrates separately from the one or more processors 302 and memory 303 in FIG. 3 for clarity, in some embodiments the sensor controller 304 may be implemented in the form of software instructions stored in the memory 303 and executed by the one or more processors 302. In some embodiments, the sensor controller 304 may be omitted.

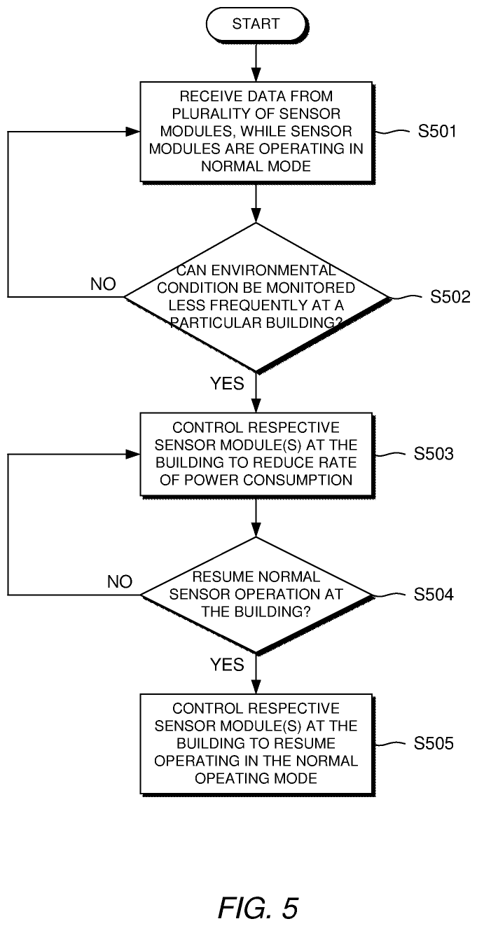

As described above, in some embodiments a sensor module 101 and/or the server 130 may comprise a sensor controller 202, 304 for controlling operations of the sensor module 101. FIG. 5 is a flowchart showing a method of controlling a sensor module to reduce the rate of power consumption by the sensor module, according to an embodiment of the present invention. A method such as the one shown in FIG. 5 can be performed by either the sensor controller 202 in a sensor module 101, or by a sensor controller 304 in the server 130 in order to remotely control a sensor module 101.

First, in step S501 the sensor controller 202, 304 receives data from the one or more sensors 201 while the sensor module that includes the sensor(s) is operating in a normal operating mode. Here, the ‘normal’ operating mode is one in which the sensor module 101 records data from the one or more sensors 201 at a first sampling rate, and/or transmits data to the server 130 regularly at a first data transmission interval (e.g. every hour, day, week, month, or so on).

When the method is implemented in a sensor controller 304 at the server 130, in step S501 the sensor controller 304 may receive data from a plurality of sensor modules 101. When the method is implemented in a sensor controller 202 included in one of the sensor modules 101, in step S501 the sensor controller 202 may only receive data from the one or more sensors 201 included in the same sensor module 101 as the sensor controller 202. In some embodiments, when the method is implemented in a sensor controller 202 included in one of the sensor modules 101, in step S501 the sensor controller 202 may receive data from other sensor modules, alone or in addition to receiving data from the one or more sensors 201 included in the same sensor module 101 as the sensor controller 202, so as to remotely control other ones of the sensor modules 101.

Next, in step S502 the sensor controller 202, 304 determines whether at least one predefined criterion is satisfied by the received sensor data, the at least one predefined criterion being indicative of a circumstance under which the environmental condition can be monitored less frequently. For example, the predefined criterion may be that the values of the respective one or more parameters measured by the sensor module remain within a certain range over at least a minimum length of time, for example 3 months, indicating that environmental conditions within the building are relatively stable. As another example, the predefined criterion may be that the values of the respective one or more parameters measured by the sensor module are indicative of an environmental condition associated with a low likelihood of the undesired condition occurring. An example of such a condition could be a temperature above a certain threshold, such that growth of mould is unlikely to occur. In this way, embodiments of the invention can help to conserve power under circumstances in which the undesired condition is deemed less likely to occur in one or more of the plurality of buildings 111, 112, 113, 114, 115.

As a further example, the predefined criterion may be that the current time is within a defined time period associated with a low likelihood of the undesired condition occurring. Depending on the embodiment the time period may be defined as a certain time of day, or as certain days/weeks/months of the year. For example, the time period may be defined from 1 June through to 30 August, on the basis that undesired conditions such as low temperatures and/or high relative humidities are less likely to occur during the summer months. It will be appreciated that these dates are provided merely as one example, and different time periods may be defined depending on the location and the typical weather conditions that are expected that location at certain times of year. In this way, embodiments of the invention can help to conserve power at times when it is less important to regularly monitor environmental conditions one or more of the plurality of buildings 111, 112, 113, 114, 115.

When the predefined criterion is found to be satisfied at step S502, the sensor controller 202, 304 proceeds to step S503 and controls the respective sensor module(s), i.e. the sensor module(s) from which the sensor data was received that satisfied the predefined criterion, so as to reduce a rate of power consumption by said sensor module(s). Controlling a sensor module 101 to reduce the rate of power consumption may also be referred to as switching the sensor module 101 into a low-power operating mode, compared to the normal operating mode. The manner in which power consumption by a sensor module 101 is reduced in the low-power operating mode may vary depending on the embodiment. For example, in one embodiment in step S503 the sensor controller 202, 304 may control a sensor module 101 so as to decrease a sampling rate at which the sensor module 101 measures at least one of the one or more parameters using the one or more sensors 201, thereby to reduce the rate of power consumption by the sensor module 101.

In another embodiment, in step S503 the sensor controller 202, 304 may control a sensor module 101 so as to increase a time interval at which the sensor module 101 transmits its data to the server 130, thereby to reduce the rate of power consumption by the sensor module 101. Purely by way of an example, in one embodiment a self-powered sensor module 101 has an internal battery 204 with a capacity of 6000 mAh (milliamp hours) and records a sensor reading at hourly intervals. In this example, transmitting data to the server draws 80 mA of current from the battery 204 for a period of 30 seconds, and recording a measurement from a sensor 201 draws 10 mA of current from the battery 204 for a period of 0.01 seconds. Under these conditions, if data is recorded every hour and also transmitted to the server every hour, the battery would be expected to be discharged after approximately 9 months of continuous operation. However, if the sampling rate remains the same but data is cached in local memory at the sensor module 101 and only transmitted to the server 130 once per day, the battery life can be extended up to approximately 3.5 years of continuous operation. As a further example, if the sampling rate remains the same but data is cached in local memory at the sensor module 101 and only transmitted to the server 130 once per month, the battery life can be extended up to approximately 4.1 years of continuous operation.

It will therefore be appreciated that transmitting data to the server at longer time intervals, and similarly recording sensor data at lower sampling rates, can help to prolong the operating life of a sensor module 101 and reduce the frequency with which sensor modules 101 have to be replaced, or with which the internal battery 204 of a sensor module 101 has to be recharged or replaced. In some embodiments both approaches may be implemented together to further reduce the power consumption, in other words, the sensor module 101 may be controlled both to decrease the sampling rate and to increase the time interval at which data is transmitted to the server 130.

In other embodiments, other methods of reducing power consumption at a sensor module 101 may be implemented in step S503, instead of or in addition to those described above. In some embodiments the sensor module 101 may be switched into a sleep mode in which certain components and/or functions of the sensor module 101 are disabled or switched into a low-power operating mode. For example, the one or more sensors 201 and/or the wireless interface 203 may be disabled until the sensor module 101 is switched back from the sleep mode into the normal operating mode.

In step S504, the sensor controller 202, 304 determines whether to resume normal sensor operation at the building. If it is determined to resume normal sensor operation, then in step S505 the sensor controller 202, 304 controls the sensor module(s) 101 that were switched into the low-power operating mode in step S503 to switch back into the normal operating mode. In step S504, the condition under which it is determined to resume normal sensor operation may depend on the predefined criterion that was applied in step S502.

For example, in an embodiment in which the predefined criterion at step S502 is that the values of one or more parameters measured by the sensor module 101 remain within a certain range over at least a minimum length of time, and in which the sensor module 101 is switched into a sleep mode in step S503, in step S504 the sensor controller 202, 304 may be configured to periodically wake the sensor module 101 from the sleep mode to re-measure the one or more parameters indicative of the environment condition, and to switch the sensor module 101 back into the normal operating mode in step S505 in dependence on the re-measured value of the one or more parameters deviating from a previously-measured value by more than a threshold amount.

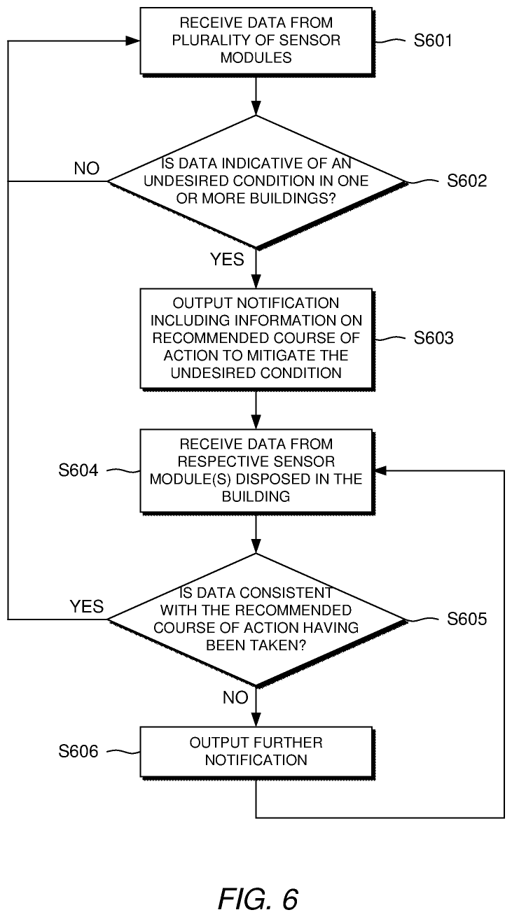

Referring now to FIG. 6, a flowchart showing a method of alerting a user when an undesired condition has been detected, and checking whether the recommended corrective action has been taken, is illustrated according to an embodiment of the present invention. The method can be performed by the server 130 in the apparatus of FIG. 1, and may for example be implemented in the form of computer program instructions stored in the server's memory 303 and executed on the one or more processors 302. Steps S601 and S602 can be performed in a similar manner to steps S401 and S402 of FIG. 4, as described above, and as such a detailed explanation will not be repeated here.

In the embodiment shown in FIG. 6, the predefined corrective action that is taken by the server in step S603 when the undesired condition is detected comprises outputting a notification indicative of the undesired condition, the notification including information on a recommended course of action to mitigate the undesired condition. For example, when the undesired condition is an environmental condition known to be conducive to mould growth, such as a high % RH value or a particular combination of T and % RH values, the notification may take the form of a message advising the resident to increase the level of ventilation at the building.

Furthermore, in the present embodiment after the notification has been provided in step S603, in step S604 the server 130 receives data indicative of values of the respective one or more parameters measured by one or more of the plurality of sensor modules 101 disposed within the building in which the undesired condition was detected at a time after the notification was outputted. Then, the server 130 subsequently determines in step S605 whether the recommended course of action has been followed, based on the new sensor data received in step S604. In the example in which the notification takes the form of a message advising the resident to increase the level of ventilation at the building, in step S605 the server 130 may compare the new sensor data that was received in step S604 to the previous sensor data that was received in step S601, to check for a change in the sensor data (e.g. T and/or % RH values) that is consistent with an increased level of ventilation. If it is determined that the recommended course of action has been followed, then the server 130 returns to step S601 and continues to monitor the sensor data in step S602 for a recurrence of the undesired condition, or indeed an occurrence of a different undesired condition.

If no such change is detected, then the server 130 determines that the recommended course of action has not been followed, and proceeds to output a further notification in step S606. Steps S604, S605 and S606 may be repeated as necessary until the sensor determines that the recommended course of action has been followed.

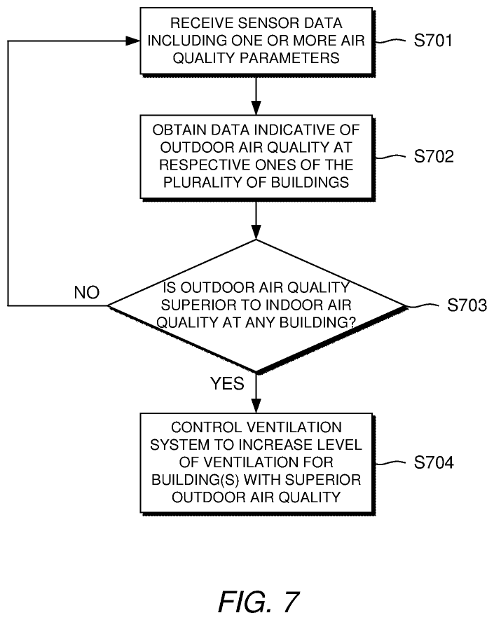

Referring now to FIG. 7, a flowchart showing a method of automatically controlling a ventilation system is illustrated, according to an embodiment of the present invention. The method can be performed by the server 130 in the apparatus of FIG. 1, and may for example be implemented in the form of computer program instructions stored in the server's memory 303 and executed on the one or more processors 302. Step S701 is similar to step S401 of FIG. 4, as described above, and as such a detailed explanation will not be repeated here. The data that is received in step S701 includes one or more values of a measured parameter relating to air quality, such as an air quality index (AQI) value.

In step S702 the server 130 obtains other data that is indicative of an outdoor air quality at the respective building from which the sensor data was received in step S701. In one embodiment, in step S702 the server 130 may receive the data indicative of the outdoor air quality from a sensor module 101 disposed outside the building, so as to measure the outdoor air quality. In another embodiment, in step S702 the server 130 may obtain the data indicative of the outdoor air quality from another source, for example from an online weather service that provides air quality data for an area in which the building is located. As yet a further example, in some embodiments the server may obtain the data in step S702 simply by retrieving a default value from memory 303, which may be set to a value that is known to be typical of an outdoor air quality at the building.

In step S703, the server 130 proceeds to compare the data indicative of the indoor air quality, i.e. the data that was received in step S701, to the data indicative of the outdoor air quality that was obtained at step S702. If it is determined that the outdoor air quality is superior to the indoor air quality, then in step S704 the server 130 proceeds to remotely control a ventilation system at the building so as to increase a level of ventilation at the building. In this way, the server 130 can automatically take action to improve the air quality within the building without the need for human intervention. In some embodiments, the server 130 may only control the ventilation system in step S704 if the indoor air quality is below a threshold, in other words, if the data indicates that the indoor air quality is relatively low, and if the outdoor air quality is also superior to the indoor air quality.

In some embodiments, the server may automatically control the ventilation system using a similar method to the one shown in FIG. 7 for other undesired conditions, instead of or in addition to a condition in which the indoor air quality is lower than the outdoor air quality. For example, a similar method may be used to automatically increase ventilation when an undesired condition such as a high CO₂, high CO or high NOx level is detected in step S703.

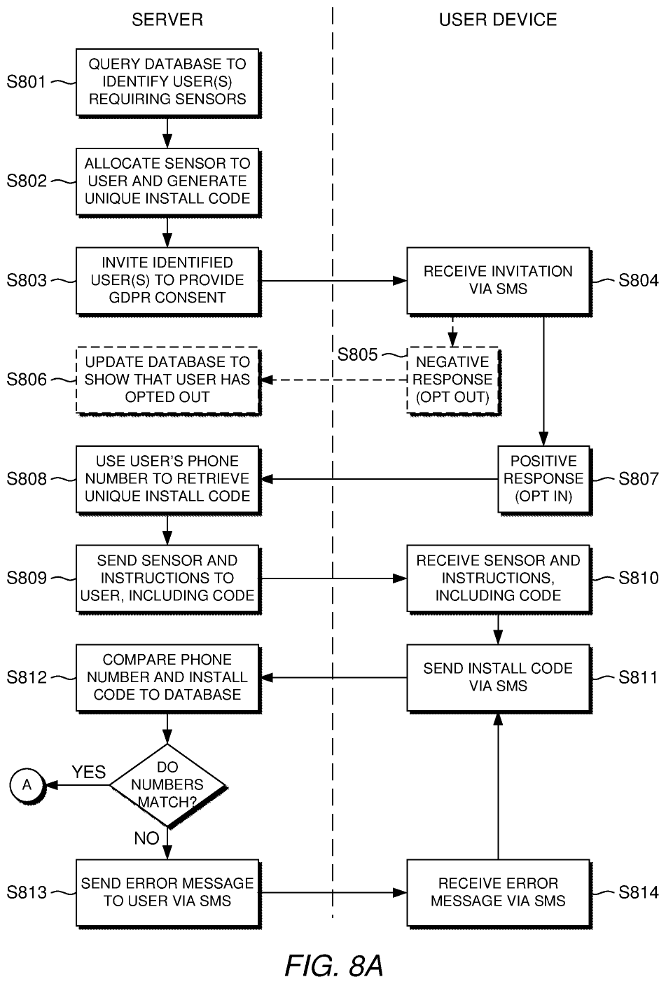

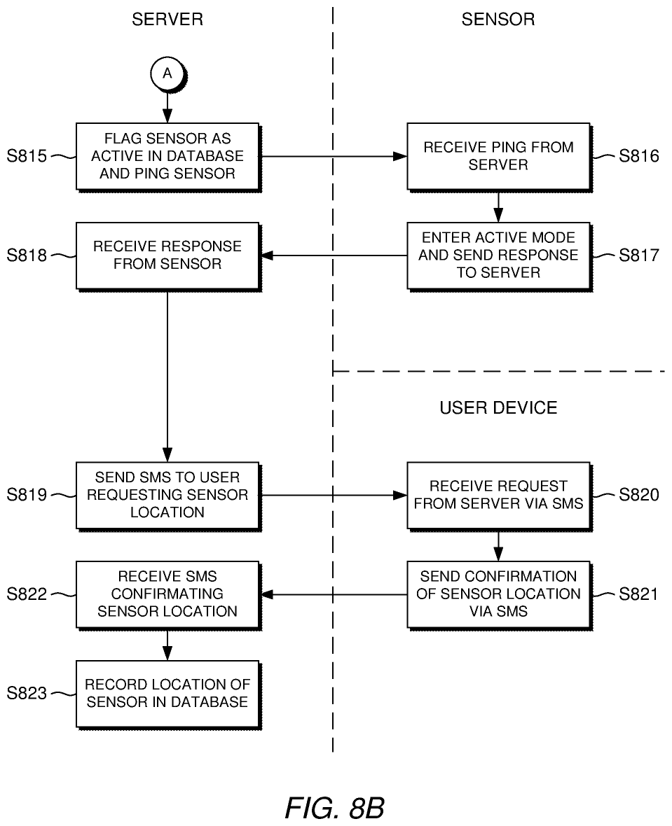

Referring now to FIGS. 8A and 8B, a method of registering a new sensor in a remote monitoring system, such as the one shown in FIG. 1, is illustrated according to an embodiment of the present invention. The method illustrated in FIGS. 8A and 8B can be performed whenever it is desired to add a new sensor module 101 to the system illustrated in FIG. 1. In the present embodiment, certain steps are described as being performed respectively by the server 130, user device 150, and sensor module 101 of the system of FIG. 1, however, in other embodiments some or all of the steps may be performed at other devices.

First, in step S801 the server 130 queries a database to identify one or more users that require a new sensor module 101. Depending on the embodiment, the database may be stored locally at the server 130 or may be a collection of one or more remote database(s) that is/are accessible to the server 130. For example, the database may store a record of a plurality of users, such as individual residents, households or landlords, and may be updated to add new users to the system. The record for each user may contain information for identifying the user, such as the user's name. The record for each user may contain contact information for contacting the user, such as the user's address, email address and/or phone number. For example, in some embodiments new users may complete a web-based registration process to submit their details which can then be used to create a new record in the database. Examples of such details that may be submitted by a new user during the registration process include, but are not limited to, name, address, email address and/or phone number, age of the property, number of occupants, number of sensor modules required, fuel poverty status, and a history of any conditions that have previously been identified in the building, for example whether mould or damp have previously been detected. In some embodiments the details for a new user may be submitted by a third party, for example, details of a new tenant as a new user may be submitted by the landlord on the tenant's behalf, or by another party such as a lettings agency or estate management service.

The database can also record, for each user, whether that user requires a new sensor module 101. For example, whenever a new user is added to the database, the database may automatically flag that user as requiring a new sensor module 101 since the user is joining the system for the first time. The database may also flag existing users as requiring one or more new sensor modules 101, for example if an existing user has requested a replacement sensor module 101 or additional sensor modules 101.

When queried by the server 130 in step S801, the database may return a list of all users that have been flagged as requiring a new sensor module 101. In some embodiments, when the number of users that have been flagged as requiring a new sensor module 101 exceeds a preset number, the database may only return a list comprising the preset number of users when queried in step S801, so as to limit the total number of users being processed at any given time in the method of FIGS. 8A and 8B. The method could then be repeated as many times as needed until all users who are flagged as requiring a new sensor module 101 have been processed.

Then, in step S802 the server 130 allocates one or more sensor modules 101 to each user that was identified in step S801, depending on the number of sensor modules 101 that are required by each user. For each sensor module 101 that is allocated to a user in step S802, the server generates a unique install code, which may also be referred to as the Primary Key. In the present embodiment the unique install code takes the form of a long integer that is randomly generated by the server 130.

Next, in step S803 the server S803 sends an invitation to each of the user(s) identified in step S801 to provide their consent for their personal data to be stored and processed in the database. For example, such consent may be required to comply with local legislation, such as the General Data Protection Regulation (GDPR) in the UK and the European Union. The form in which the invitation is sent in S803 may depend on the embodiment, and on the contact information that is held in the database for any given user. For example, in the present embodiment the invitation is preferably sent as a Short Messaging Service (SMS) message, also referred to simply as a ‘text message’, if a phone number is recorded for that user in the database. If a phone number has not been provided, then the invitation may be sent in another form in step S803, for example as an email and/or as a physical letter sent through the post to the user's address. The invitation is received by the user device 150 in step S804, for example when the request has been sent in the form of an SMS or email.

Once they have received the request, the user may then choose to either opt out from, or opt into, the remote building monitoring system. If the user chooses to opt out, they can reply with a negative response in S805, indicating that they do not consent to their personal data being stored and processed in the database. In that event, the server 130 updates the database in step S806 to show that the user has opted out, and may delete their personal data such as name, address, email address and/or phone number.

If on the other hand the user replies with a positive response in step S807, indicating that they give their consent to have their personal data stored and processed in the database, then the server 130 searches for the phone number in the database to identify the user who has provided their consent, and updates the record for that user to show that they have consented. It will be appreciated that in embodiments in which a user's consent is not required to store and process their personal data, steps S803 to S807 may be omitted.

When the response sent in step S807 is received by the server 130, in some embodiments if the server 130 is unable to find a match for the sender's phone number in the database, the server may flag this as an error to be investigated by a human operator. For example, such a situation may arise when the user changes their phone number between receiving the invitation in step S804 at their old phone, and sending a response from their new phone in step S807. Similarly, such a situation may arise when a user receives the invitation and then asks another person to respond on their behalf, using a different phone.

Then, once the response has been received and the phone number from which the response was sent has been matched to one in the database, in step S808 the server 130 uses the phone number to retrieve the corresponding unique install code that was generated for that user in step S802. The server 130 then generates installation instructions including the unique install code, and arranges for the sensor module and the installation instructions to be sent to the user in step S809. As with step S803, the form in which the installation instructions are sent out may differ depending on the embodiment. In the present embodiment, a link to view the installation instructions online is sent via SMS. In another embodiment the installation instructions may be printed and sent out in physical form together with the sensor module 101, instead of or in addition to sending the installation instructions, or a link to the installation instructions, in an electronic form such as an SMS or email.

In the present embodiment, in step S809 the server 130 may also record sensor identification (ID) information for the sensor module 101 against the user's record in the database, to subsequently allow the user to be identified based on the sensor ID, or vice versa. This may be achieved by having a human operator or an automated system scan an ID on or in the packaging for the sensor module 101 before it is sent out to the user. In the present embodiment the sensor ID is provided in the form of a QR code printed on the outside of the packaging for the sensor module 101. In other embodiments the sensor ID may be provided in a different physical form, for example, as a radio-frequency identification (RFID) tag either contained inside or fixed to the outside of the packaging for the sensor module 101. By recording the sensor ID in the record for a particular user in the database, the server 130 can check a certain time later (e.g. 1 week) whether the user has confirmed that they have received a sensor module 101 with that sensor ID, as confirmation that the sensor module 101 has been successfully delivered. If no such confirmation has been received, the server 130 May take suitable action, for example by sending a reminder to the user to complete the installation process.

In step S810 the user device 150 receives the instructions, including the code. The user then follows the installation instructions to install the sensor module 101, which May involve placing or fixing the sensor module 101 in a suitable location within the building. The user device 140 is used to send back the unique install code to the server 130 via an SMS in step S811. When the sensor module 101 is a self-powered sensor module 101, the sensor module 101 could be activated so as to start transmitting data at the time when it is sent out in step S809, meaning that no action is required at the user's end other than finding a suitable location for the sensor module 101 and obtaining the sensor's ID. When the sensor module 101 is a mains-powered sensor module 101, the process of installing the sensor module 101 in the building also involves connecting the sensor module 101 to the mains power supply so that the sensor module 101 can be switched on and start transmitting data.

In step S812, the server 812 compares the phone number from which the SMS was sent in step S811, as well as the received unique install code, to the corresponding information that is stored in the database for that user. Here, the phone number can be used to look up the corresponding unique install code in the database, so that this can then be matched to the corresponding value that was included in the SMS. Again, it should be understood that use of SMS is not essential in steps S811 and S812, and in other embodiments the unique install code and sensor ID could be received from the user by other means, for example as a paper form sent via the post and then automatically or manually entered into the database, and/or via another form of communication such as email or a telephone call.

If the server 130 finds that one or both of the phone number and the unique install code received in step S812 do not match the corresponding values held in the database, then in step S813 the server 130 sends an error message to the user, which is received by the user device in step S814. The error message may prompt the user to resend the SMS in step S811, in case there was an error in entering the information in the previous instance. In the present embodiment the error message is also sent and received in the form of an SMS in steps S813 and S814, but in other embodiments the error message could be provided in a different form, for example as an email, telephone call or physical letter sent through the post.

On the other hand, if the server 130 confirms that both the phone number and the unique install code are a match for the corresponding values recorded in the database for that user, then the server proceeds to activate the sensor module 101 remotely and flag the sensor module 101 as active in the database. For example, this may be achieved by changing the value of a Boolean flag associated with the sensor ID from ‘FALSE’ to ‘TRUE’, where a value of ‘TRUE’ indicates that the sensor module 101 has been correctly received and installed.

Here, ‘activating’ the sensor module 101 refers to putting the sensor module 101 into an operating mode in which it is actively recording data from its sensor(s) and transmitting the recorded data back to the server 130 via the communications link, for example via GSM. In the present embodiment the sensor module 101 is activated via steps S815-S817 once the unique install code has been successfully received and matched with the corresponding phone number in step S812. However, in other embodiments a self-powered sensor module 101 could be activated at a different time in the sensor registration process of FIGS. 8A and 8B, since in principle the sensor module 101 can be activated at any time, and it is not essential to wait until the sensor module 101 has been installed at the building. For example, in some embodiments the sensor module 101 may be activated by pinging the sensor module 101 shortly before the sensor module 101 is sent out to the user in step S809, or may be activated even earlier in the process (e.g. when allocating the sensor to a user in step S802). Activating the sensor module 101 before it is sent out to the user can allow the server 130 to verify that it is able to receive data from the sensor module 101, in turn allowing faulty sensor modules 101 to be detected, and either fixed or rejected, before they are sent out to users. On the other hand, waiting until the sensor module 101 has been installed at the building, as in the present embodiment, can provide an advantage by maximising the time for which the sensor module 101 can operate in the building before its internal power source is depleted, since the sensor module 101 can consume less power before it is switched into the active mode.

In more detail, in the present embodiment the server 130 activates a sensor module 101 by sending a ping to the sensor module 101 in step S815, which receives the ping from the server 130 in step S816. In the present embodiment the ping causes the sensor module 101 to switch from a standby mode into an active mode, in which the sensor module 101 starts to record and transmit data wirelessly back to the server 130. The sensor module 101 may also reply to the ping in step S817 by sending a response to the server, which receives the ping response in step S818. In the present embodiment, the server 130 and the sensor module 101 communicate via a GSM communication link, and both the ping and the ping response can take the form of data packets sent between the server 130 and the sensor module 101 over the GSM communication link. Again, the use of SMS messages is not essential, and in other embodiments the ping and the ping response may be sent in a different form, for example depending on the type of communication link that is provided between the server 130 and sensor module 101. If the server 130 does not receive a ping response in step S818 a certain time after sending the ping in step S815, the server 130 may attempt to re-send the ping, and/or may take other action such as alerting the user to investigate further in case there is a fault with the sensor module 101.

Once the server 130 has received the ping response in step S818, and thereby confirmed that the sensor module 101 is active and functioning correctly, in step S819 the server 130 sends a request to the user to confirm the location in which the sensor module 101 has been installed. The user receives the request at the user device 150 in step S820 and replies with a message confirming the location of the sensor module 101 in step S821, which is received by the server 130 in step S822. In the present embodiment, the request sent by the server 130 in step S819 and the reply sent by the user device 150 in step S821 both take the form of SMS messages. However, as before, it will be appreciated that the use of SMS is not essential, and in other embodiments one or both of the request and the reply in steps S819 to S822 may take a different form.

The manner in which the user confirms the location of the sensor module 101 in step S821 may differ depending on the embodiment. In the present embodiment, the request sent by the server 130 prompts the user to reply using a numerical code-based system, in which for example a reply of ‘1’ may denote that the server module 101 is installed in the kitchen, a reply of ‘2’ may denote that the server module 101 is installed in a hallway, a reply of ‘3’ may denote that the server module 101 is installed in the main bathroom, and so on. In other embodiments a different approach may be used, for example, the user may reply with a free-text based description of the sensor's location in step S821, which could either be stored in the as-received form in the database or could be analysed using a natural language processing algorithm and converted to one of a plurality of predefined location types.

Finally, in step S823 the server 130 records the location of the sensor module 101 in the database, in association with the sensor ID for that sensor module 101. This allows the server 130 to subsequently retrieve the location of each sensor module 101 associated with a particular user, since the sensor ID is associated both with that user and with the location of that sensor module 101 in the database. For example, the server 130 can also store other information such as photos taken during a home visit to the building in which the sensor module 101 is installed, notes, information on recommended repairs to the building, and so on, which can be associated with a particular location in the building. In some embodiments, if a response confirming the location of the sensor has not been received by a certain time, for example one week after the request was sent out in step S819, the server 130 may be configured to assign a default location to the sensor module 101 in the database, for example ‘other’ or ‘unknown’. The actual location of the sensor module 101 could then be entered into the database at a subsequent time, for example during a home visit or when speaking to user on the phone.

In some embodiments, the server 130 may be configured to automatically generate a report at regular intervals, for example each month, based on data received from sensor modules 101 associated with a particular user. Each sensor module 101 includes its own sensor ID when transmitting data back to the server 130, so that the server 130 module can determine the location at which the data was recorded, by looking up the stored location of the sensor module 101 in the database using the sensor ID. The report can include information on the data that was received for each location, for example in the form of a graph plotting the data over time, and/or a written description of any noteworthy patterns that may have been identified in the data by the server 130 (e.g. whether an undesired condition has been detected). The report may also contain other information that is held in the database associated with that location, such as photos, notes, and information on recommended repairs, as described above. Such a report may be automatically sent out to the user by the server 130 when it is generated.

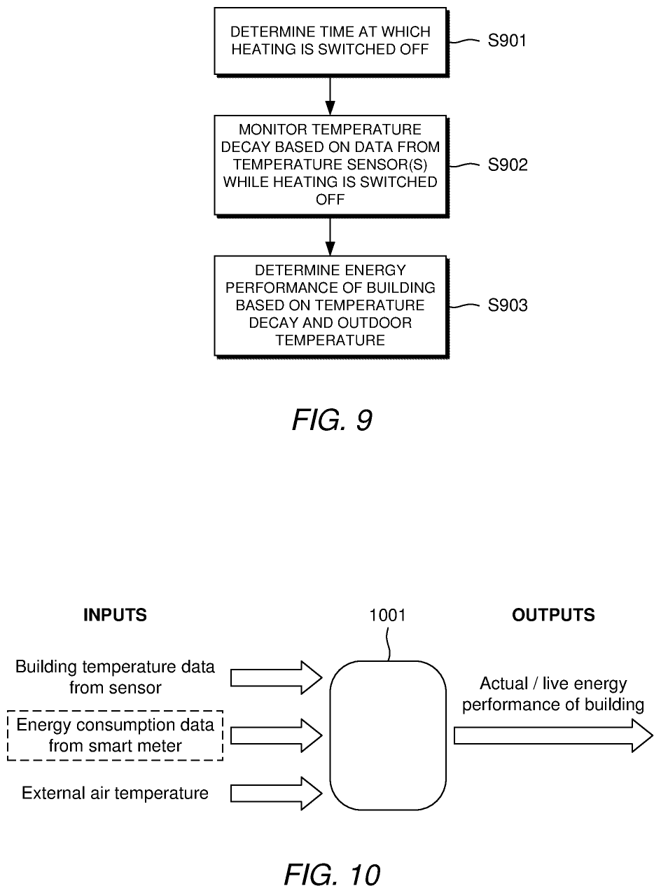

Referring now to FIGS. 9 and 10, a method of determining an actual energy performance of a building based on data from one or more temperature sensors disposed within the building is illustrated, according to an embodiment of the present invention. A method such as the one shown in the flowchart of FIG. 9 can be used to determine the actual energy efficiency of a building, as opposed to existing approaches, which typically involve estimating the energy efficiency of a building based on information about its size, construction materials, insulation, and so on.

A system capable of implementing the method is illustrated in FIG. 10, comprising an algorithm 1001 (for example, in the form of computer program instructions executed on the server 130) configured to receive as inputs: (i) the temperature data from one or more sensor modules 101 disposed in a building; and (ii) data indicative of an external air temperature outside the building.

First, in step S901 the algorithm 1001 determines a time at which the building's heating system(s) is/are switched off. For example, this may be determined when a sudden decrease in energy consumption by at least a threshold amount is observed in the smart meter data, which may be indicative of the heating system(s) having been deactivated.

At this point, since the building is no longer being heated, the temperature of the building will start to drop over time as the building loses heat to the outside environment (assuming that the external temperature is lower than the internal temperature). In step S902, the algorithm 1002 monitors the rate at which the temperature measured by each sensor module 101 within the building decreases over time while the heating system(s) remains switched off. Then, in step S903 the algorithm 1001 uses the observed rate of temperature decay and the outside temperature to determine the actual energy performance of the building.

In the present embodiment, the algorithm 1001 determines the energy performance of the building, U, which is the overall heat transfer coefficient measured in Watts per square metre per degree Celsius (W/m²° C.), based on the following equation:

$$U = Q / ( A d T )$$

where Q is the rate at which heat is transferred from the inside to the outside of the building (measured in Watts, W), A is the external surface area of the building in square metres (m²), and dT is the difference in temperature between the inside temperature and the external temperature.

The value of A can be known in advance and stored in the database, for example by asking the user to provide a value of A for the building when first registering a new building with the system in step S801. The algorithm 1001 may determine dT based on the temperature data received from the one or more sensor modules disposed within the building, and based on the received data indicative of the external temperature. In one embodiment, the algorithm 1001 may obtain the data indicative of the external temperature from an external sensor module disposed on the outside of the building, so as to measure the external temperature. In another embodiment, the algorithm 1001 may obtain the data indicative of the external temperature from another source, for example an online weather forecasting service that provides temperature data at for the building's location.

The algorithm 1001 can determine the value of Q based on the observed rate of change of the internal temperature over time, as determined from the temperature data received from the one or more sensor modules 101 disposed in the building, provided that the rate at which heat energy is being provided to the building is also known. In the embodiment shown in FIG. 9, since the method starts at a time when the heating system is switched off in step S901, the algorithm 1001 can assume that the rate at which heat energy is being supplied to the building is zero, and can proceed to calculate a value of Q based on the observed decay in the temperature measured by the one or more sensor modules 101.

However, in other embodiments the algorithm 1001 can be configured to obtain a third type of input data, (iii), comprising data indicative of an actual energy consumption by one or more heating systems in the building, as shown in FIG. 10. In such embodiments, the algorithm 1001 can calculate Q based on both inputs (i) and (iii) without having to wait for the heating system to be switched off, in which case step S901 can be omitted and the calculation can instead be performed at any time. Data indicative of the actual energy consumption by the heating system may be received from a smart meter installed in the building, or from a heat network configured to supply heat and/or energy to the building. Furthermore, in some embodiments the smart meter data may separately identify the amount of energy that has been consumed by the heating system per unit time, versus an amount of energy that has been consumed by other systems, devices etc. within the building (e.g. lighting circuit, power circuit, and so on), allowing the algorithm 1001 to more accurately determine the amount of heat energy that is provided to the building.

In some embodiments, the algorithm 1001 may receive data indicative of the actual energy consumption by one or more heating systems from a source other than a smart meter. In such embodiments, the sensor that provides the data indicative of actual energy consumption may be referred to as an energy consumption sensor. For example, in some embodiments an energy consumption sensor may use a magnetic field sensor to obtain data indicative of energy consumption by a gas-powered heating system. The magnetic field sensor may detect the rate of flow of gas by counting magnetic pulses, for example, as the result of a rotating component inside the gas meter being driven to rotate by the flow of gas. The magnetic field sensor may therefore be disposed on the gas meter in the building, so as to detect the rate of flow of gas through the gas meter. Modern gas meters commonly include such a rotating component that can be detected in this way by a magnetic field sensor, and so the sensor can easily be attached to the gas meter in the appropriate location without requiring any modification of the meter itself. As another example, in some embodiments an optical sensor may be used to count optical pulses, instead of using a magnetic field sensor. For instance, optical sensors may be used to detect the rate at which electrical energy is consumed.

In embodiments in which the algorithm 1001 receives data indicative of the actual energy consumption from an energy consumption sensor as opposed to from a smart meter, the data may be received via any suitable communications link, for instance via a Wi-Fi or GSM link or by relaying the data via a Bluetooth connection to one of the sensor modules installed in the building. In some such embodiments, the energy consumption sensor may store data collected over a period of time in local memory, and periodically upload data to the server at longer time intervals so as to reduce the power that is consumed by the process of uploading data, and hence extend a battery life of the sensor (i.e. if a battery-powered sensor is used). In some embodiments, data indicative of the actual energy consumption could be manually downloaded at the sensor, instead of being transmitted wirelessly to the server.

When the rate at which energy is consumed by the heating system is known to the algorithm 1001, for example as a volume of gas consumed by the heating system per unit time, this can be converted into an estimate of the rate at which heat energy is being provided to the building. For example, the algorithm may assume an efficiency of 85% for a typical gas boiler, and so may multiply the rate at which gas is consumed by the heating system by a factor of 0.85 to estimate the rate at which heat energy is provided to the building, which is typically expressed as kilowatt-hours (kWh). A value for Q can then be determined based on this estimate and the observed change in internal temperature of the building, as measured by the one or more sensor modules 101.

Conventionally, determining a building's actual energy performance would require specialist analysis, which is typically costly both in terms the equipment involved and the required manpower for set-up and data analysis. However, by utilising data from one or more sensor modules 101 in combination with data indicative of the actual energy consumption by a heating system and data indicative of the external air temperature, as described above, embodiments of the present invention can provide a quicker, cheaper, more convenient solution for measuring a building's actual energy performance in real-time. Furthermore, by automating the process of determining an actual energy performance, embodiments of the invention can allow landlords, housing associations etc. to quickly and easily compare the performance of a number of properties. Access to such information may be particularly useful when comparing properties of similar types, for example a number of buildings, flats etc. of similar construction, making it easy to identify properties that are performing worse than others of similar type and which may therefore require some form of intervention, for example repairs or modifications, to improve their energy performance.

Whilst certain embodiments of the invention have been described herein with reference to the drawings, it will be understood that many variations and modifications will be possible without departing from the scope of the invention as defined in the accompanying claims.

1. Apparatus for remote monitoring of environmental conditions within a plurality of buildings, the apparatus comprising:
a plurality of sensor modules each disposed within a respective one of the plurality of buildings, each sensor module being configured to measure one or more parameters indicative of an environmental condition, the plurality of sensor modules including one or more self-powered sensor modules each comprising an internal power source for powering said sensor module; and
a server communicatively coupled to the plurality of sensor modules to receive data indicative of values of the respective one or more parameters measured by each of the plurality of sensor modules, the server being disposed at a location remote from the plurality of buildings,
wherein the server is configured to determine whether the received data is indicative of an undesired condition in at least one of the plurality of buildings, and take a predefined corrective action to mitigate said undesired condition in dependence on a determination that the received data is indicative of the undesired condition.

2. The apparatus of claim 1, wherein the apparatus comprises:
a sensor controller configured to control one of the plurality of sensor modules so as to reduce a rate of power consumption by said sensor module in dependence on a determination that at least one predefined criterion is satisfied, the at least one predefined criterion being indicative of a circumstance under which the environmental condition can be monitored less frequently.

3. The apparatus of claim 2, wherein the sensor controller is configured to decrease a sampling rate at which the sensor module measures at least one of the one or more parameters, thereby to reduce the rate of power consumption by the sensor module.

4. The apparatus of claim 2, wherein the sensor controller is configured to increase a time interval at which the sensor module transmits its data to the server, thereby to reduce the rate of power consumption by the sensor module.

5. The apparatus of claim 2, wherein the sensor controller is configured to switch the sensor module from a normal operating mode into a sleep mode in which one or more functions of the sensor module are disabled, thereby to reduce the rate of power consumption by the sensor module.

6. The apparatus of claim 5, wherein the sensor controller is configured to periodically wake the sensor module from the sleep mode to re-measure the one or more parameters indicative of the environment condition, and to switch the sensor module back into the normal operating mode in dependence on the re-measured value of the one or more parameters deviating from a previously-measured value by more than a threshold amount.

7. The apparatus of claim 2, wherein the at least one predefined criterion indicative of a circumstance under which the environmental condition can be monitored less frequently comprises:
the values of the respective one or more parameters measured by the sensor module remaining within a certain range over at least a minimum length of time; and/or
the values of the respective one or more parameters measured by the sensor module being indicative of an environmental condition associated with a low likelihood of the undesired condition occurring; and/or
a current time being within a defined time period associated with a low likelihood of the undesired condition occurring.

8. The apparatus of claim 2, wherein the server comprises the sensor controller.

9. The apparatus of claim 2, wherein the sensor controller is disposed in the sensor module, such that each of the plurality of sensor modules comprises a respective sensor controller.

10. The apparatus of claim 1, wherein the one or more self-powered sensor modules each comprise:
at least one sensor for measuring the one or more parameters; and
a communications interface for transmitting the data to the server;
wherein the internal power source is configured to supply electrical power to the at least one sensor and the communications interface.

11. The apparatus of claim 1, wherein the plurality of sensor modules include one or more mains-powered sensor modules, each mains-powered sensor module comprising:
at least one sensor for measuring the one or more parameters;
a communications interface for transmitting the data to the server; and
a mains power adaptor connectable to a source of mains power to supply electrical power to the at least one sensor and the communications interface.

12. The apparatus of claim 1, wherein the server is communicatively coupled to one or more of the plurality of sensor modules via a Global System for Mobile, GSM, communications network.

13. The apparatus of claim 1, wherein the one or more parameters measured by the plurality of sensor modules include one or more of:
ambient temperature;
ambient humidity;
a concentration of carbon dioxide;
a concentration of carbon monoxide;
a concentration of nitrous oxide species, NOx;
an air quality index, AQI;
a concentration of particulate matter;
a concentration of smoke particles;
a concentration of volatile organic compounds, VOCs; and
an ambient noise level.

14. The apparatus of claim 1, wherein the undesired condition comprises one or more of:
a temperature and/or humidity condition conducive to the growth of mould;
a temperature condition indicative of a low level of insulation and/or heating;
a temperature and power usage condition indicative of an inefficient form of heating being used in the building;
a humidity condition indicative of over-occupancy of the building; and
a discrepancy between an actual energy performance of the building, as determined based on the received data, and an expected energy performance of the building.

15. The apparatus of claim 1, wherein the predefined corrective action comprises outputting a notification indicative of the undesired condition, the notification including information for identifying the building in which the undesired condition has been detected, and/or wherein the predefined corrective action comprises outputting a notification indicative of the undesired condition, the notification including information on a recommended course of action to mitigate the undesired condition.

16. (canceled)

17. The apparatus of claim 1, wherein the predefined corrective action comprises outputting a notification indicative of the undesired condition, the notification including information on a recommended course of action to mitigate the undesired condition, and wherein the server is configured to subsequently determine whether the recommended course of action has been followed, based on data indicative of values of the respective one or more parameters measured by one or more of the plurality of sensor modules disposed within the building in which the undesired condition was detected at a time after the notification was outputted, and to output a further notification in dependence on a determination that the recommended course of action has not been followed.

18. The apparatus of claim 1, wherein the one or more parameters include at least one parameter relating to an indoor air quality, such that the received data is indicative of the indoor air quality within one or more of the plurality of buildings, and
wherein the server is configured to compare the received data indicative of the indoor air quality to other data indicative of an outdoor air quality at a respective one of the plurality of buildings, and to remotely control a ventilation system to increase a level of ventilation at said one of the plurality of buildings in dependence on a determination that the outdoor air quality is superior to the indoor air quality.

19. A server for use in the apparatus of claim 1, the server comprising:
a communication interface for communicatively coupling the server to the plurality of sensor modules to receive data indicative of values of the respective one or more parameters measured by each of the plurality of sensor modules;
one or more processors; and
computer readable memory arranged to store computer program instructions which, when executed by the one or more processors, cause the server to:
determine whether the received data is indicative of an undesired condition in at least one of the buildings; and
take a predefined corrective action to mitigate said undesired condition in dependence on a determination that the received data is indicative of the undesired condition.

20. A computer-implemented method of remotely monitoring environmental conditions within a plurality of buildings, the method comprising:
receiving, at a server disposed at a location remote from the plurality of buildings, data indicative of values of respective parameters measured by at least one sensor for measuring a parameter indicative of an environmental condition in each of a plurality of sensor modules each disposed within a respective one of the plurality of buildings;
determining whether the received data is indicative of an undesired condition in at least one of the buildings; and
taking a predefined corrective action to mitigate said undesired condition in dependence on a determination that the received data is indicative of the undesired condition.

21. A non-transitory computer-readable storage medium arranged to store computer program instructions which, when executed, cause performance of a method according to claim 20.
